(19) United States
(12) Patent Application Publication
(10) Pub. No.: US 2024/0405254 A1
(43) Pub. Date: Dec. 5, 2024

(54) ENERGY-STORAGE ELEMENT AND METHOD FOR PRODUCING SAME

(71) Applicant: VARTA Microbattery GmbH, Ellwangen Jagst (DE)

(72) Inventors: Rainer STERN, Nordhausen (DE); Andreas SOLDNER, Dinkelsbuehl (DE); Martin ELMER, Ellwangen (DE)

(21) Appl. No.: 18/698,048

(22) PCT Filed: Aug. 4, 2022
(86) PCT No.: PCT/EP2022/072023

§ 371 Date: Apr. 4, 2024

(30) Foreign Application Priority Data
Oct. 5, 2021 (EP) 21200967.4

(51) Int. Cl. H01M 10/04; H01M 50/103; H01M 50/107

(52) U.S. Cl. CPC H01M 10/0431; H01M 50/103; H01M 50/107

(57) ABSTRACT

The following is known: energy-storage elements (100) comprising a cathode (101) and an anode (102), which cathode and anode are parts of a composite body (109) in that they are provided, separated by a separator layer or solid-electrolyte layer (110), in the following sequence: cathode (101)-separator layer or solid-electrolyte layer (110)-anode (102), wherein the cathode (101) and the anode (102) comprise current collectors (101a and 102a) which each have, in addition to regions (101b and 102b) coated on both sides with electrode material (117 and 118), one edge strip (101c and 102c) which is not coated with electrode material. Here, the free edge strip (101c) of the cathode current collector (101a) exits on one side of the composite body (109), and the free edge strip (102c) of the anode current collector (102a) exits on another side of the composite body (109), wherein one of the edge strips (101c, 102c) is in direct contact with a first contact sheet (119), and the other one is in direct contact with a second contact sheet (120). According to the present invention, at least one of the edge strips (101c, 102c) which is in direct contact with one of the contact sheets (119, 120) is subjected to a shaping process, so that this edge strip has a U-shaped or V-shaped cross-section and therefore an elongate recess or depression (121, 124) on one side and an elongate raised portion (122, 123) corresponding to the recess on the other side.

### CROSS REFERENCE TO RELATED APPLICATIONS

This application is a U.S. National Phase application under 35 U.S.C. § 371 of International Application No. PCT/EP2022/072023, filed on Aug. 4, 2022, and claims benefit to European Patent Application No. EP 21200967.4, filed on Oct. 5, 2021. The International Application was published in German on Apr. 13, 2023 as WO/2023/057112 under PCT Article 21 (2).

### FIELD

The present disclosure relates to an energy storage element suitable for providing very high currents and to a method of manufacturing such an energy storage element.

### BACKGROUND

Electrochemical energy storage elements can convert stored chemical energy into electrical energy by virtue of a redox-reaction. The simplest form of an electrochemical energy storage element is the electrochemical cell. It comprises a positive and a negative electrode, which are separated from each other by a separator. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is made possible by an ion-conducting electrolyte.

If the discharge is reversible, i.e. it is possible to reverse the conversion of chemical energy into electrical energy during discharge and charge the cell again, this is said to be a secondary cell. The negative electrode is generally referred to as the anode in secondary cells and the positive electrode as the cathode refers to the discharge function of the electrochemical cell.

Secondary lithium-ion cells are used as energy storage elements for many applications today, as they can provide high currents and are characterized by a comparatively high energy density. They are based on the use of lithium, which can migrate back and forth between the electrodes of the cell in the form of ions. The negative electrode and the positive electrode of a lithium-ion cell are generally formed by so-called composite electrodes, which comprise electrochemically inactive components as well as electrochemically active components.

In principle, all materials that can absorb and release lithium ions can be used as electrochemically active components (active materials) for secondary lithium-ion cells. For example, carbon-based particles such as graphitic carbon are used for the negative electrode. Active materials for the positive electrode can be, for example, lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.

As electrochemically inactive components, the composite electrodes generally comprise a flat and/or strip-shaped current collector, for example a metallic foil, which serves as a carrier for the respective active material. The current collector for the negative electrode (anode current collector) can be made of copper or nickel, for example, and the current collector for the positive electrode (cathode current collector) can be made of aluminum, for example. Furthermore, the electrodes can comprise an electrode binder (e.g. polyvinylidene fluoride (PVDF) or another polymer, for example carboxymethyl cellulose), conductivity-improving additives and other additives as electrochemically inactive components. The electrode binder ensures the mechanical stability of the electrodes and often also the adhesion of the active material to the current collectors.

As electrolytes, lithium-ion cells generally comprise solutions of lithium salts such as lithium hexafluorophosphate (LiPF₆) in organic solvents (e.g. ethers and esters of carbonic acid).

The composite electrodes are combined with one or more separators to form an assembly when manufacturing a lithium-ion cell. In this process, the electrodes and separators are usually connected under pressure, possibly also by lamination or bonding. The basic functionality of the cell can then be established by impregnating the assembly with the electrolyte.

In many embodiments, the assembly is formed in the form of a winding or processed into a winding. Alternatively, the assembly can also be a stack of electrodes.

For applications in the automotive sector, for e-bikes or for other applications with high energy requirements, such as in tools, lithium-ion cells with the highest possible energy density are required that are also capable of withstanding high currents during charging and discharging.

WO 2017/215900 A1 describes cylindrical round cells in which an assembly in the form of a winding is formed from ribbon-shaped electrodes. The electrodes each have current collectors loaded with electrode material. Oppositely polarized electrodes are arranged offset to each other within the assembly so that longitudinal edges of the current collectors of the positive electrodes protrude from one side and longitudinal edges of the current collectors of the negative electrodes protrude from another side of the winding. For electrical contacting of the current collectors, the cell has contact plates that sit on the end faces of the winding and are connected to the longitudinal edges of the current collectors by welding. This makes it possible to electrically contact the current collectors and thus also the associated electrodes over their entire length. This significantly reduces the internal resistance within the described cell. As a result, the occurrence of large currents can be absorbed much better and heat can also be dissipated better from the winding.

A potential problem here is that the edges of the current collectors are often compressed in an uncontrolled manner when the contact plates are applied, which can result in undefined folds. This makes large-area, form-fit contact between the end faces and the contact plates more difficult. In addition, the risk of fine or short circuits on the end face is elevated, for example as a result of damage to the separator located between the electrodes.

To solve this problem, WO 2020/096973 A1 proposes pretreating the edges of the current collectors, in particular removing parts of the current collector edges so that they are rectangular in shape.

Targeted pre-deformation of the edges of current collectors is known from US 2018/0190962 A1 and JP 2015-149499 A.

### SUMMARY

In an embodiment, the present disclosure provides an energy storage element. The energy storage element includes a cathode comprising a cathode current collector comprising a main region loaded on both sides with a layer of positive electrode material and a free edge strip not loaded with the positive electrode material, the free edge strip extending along an edge of the cathode current collector; an anode comprising an anode current collector comprising a main region loaded on both sides with a layer of negative electrode material and a free edge strip not loaded with the negative electrode material, the free edge strip extending along an edge of the anode current collector; and a first contact sheet metal member in direct contact with a first free edge strip and a second contact sheet metal member in direct contact with a second free edge strip, the first free edge strip being one of the free edge strip of the cathode current collector or the free edge strip of the anode current collector and the second free edge strip being the other of the free edge strip of the cathode current collector or the free edge strip of the anode current collector, wherein the cathode and the anode are separated by a separator or a solid electrolyte layer and form a sequence cathode/separator or solid electrolyte layer/anode, wherein the cathode and the anode are arranged relative to one another such that the free edge strip of the cathode current collector protrudes from one side of an assembly, the assembly comprising the cathode and the anode, and the free edge strip of the anode current collector protrudes from another side of the assembly, wherein at least one of the first free edge strip or the second free edge strip has, as a result of a forming process, a U-shaped or V-shaped cross-section and thus an elongated depression or indentation on one side and an elongated elevation corresponding to the depression on the other side, and wherein the at least one of the first free edge strip or the second free edge strip having the U-shaped or V-shaped cross section comprises a first respective turn that includes a portion of the elongated elevation that is inserted into a portion of the elongated depression or indentation comprised in a respective radially adjacent turn of the at least one of the first free edge strip or the second free edge strip.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 provides a drawing of a cross-section through a cell of the prior art, in which a contact plate has been pressed onto a projecting edge of a current collector;

FIG. 2 illustrates a current collector coated on both sides with a positive electrode material with a free edge strip not coated with electrode material (top view and cross-section);

FIG. 3 illustrates a current collector coated on both sides with a negative electrode material with a free edge strip not coated with electrode material (top view and cross-section);

FIG. 4 illustrates the formation of an edge strip with a V-shaped cross-section;

FIG. 5 illustrates a section through some turns of a cylindrical assembly formed by spirally winding a cathode and an anode;

FIG. 6 illustrates a sectional view of another embodiment of a cylindrical assembly formed by spirally winding a cathode and an anode;

FIG. 7 illustrates the formation of an edge strip with a U-shaped cross-section; and

FIG. 8 illustrates an energy storage element comprising a prismatic assembly and a housing therefor, also in cross-section.

### DETAILED DESCRIPTION

The known solutions have a disadvantage in that the pre-treatment of the current collector edges is very complex.

In contrast, the present disclosure provides energy storage elements characterized by an assembly of electrodes and possibly one or more separators, which can be contacted more easily by contact plates.

### Energy Storage Element

An energy storage element according to the present disclosure has the immediately following features a. to h:
a. It comprises a cathode and an anode which are part of an assembly in which they are separated by a separator or solid electrolyte layer and in which they are present in the sequence cathode/separator or solid electrolyte layer/anode,
b. the cathode comprises a cathode current collector and a positive electrode material,
c. the cathode current collector has
a main region loaded on both sides with a layer of the positive electrode material, and
a free edge strip which extends along one edge of the cathode current collector and which is not loaded with the positive electrode material,
d. the anode comprises an anode current collector and a negative electrode material,
e. the anode current collector has
a main region loaded on both sides with a layer of the negative electrode material, and
a free edge strip which extends along one edge of the anode current collector and which is not loaded with the negative electrode material,
f. the cathode and the anode are designed and/or arranged relative to each other within the electrode-separator assembly in such a way that the free edge strip of the cathode current collector protrudes from one side of the assembly and the free edge strip of the anode current collector protrudes from another side of the assembly,
g. the energy storage element comprises a first contact sheet metal member which is in direct contact with one of the free edge strips and a second contact sheet metal member which is in direct contact with the other of the free edge strips, and
h. at least one of the edge strips being in direct contact with one of the contact sheet metal members has a U-shaped or V-shaped cross-section as a result of a forming process, for example folding or embossing, and thus has an elongated depression or indentation on one side and an elongated elevation corresponding to the depression on the other side.

The energy storage element is therefore characterized by the fact that it has current collectors whose free edge strips have been subjected to a forming process. This enables a better connection of the current collectors to the contact sheet metal members, which in turn can reduce the thermal connection of the electrodes to the housing and the internal resistance of the cell. In addition, the risk of an internal short circuit is also reduced, as the U- or V-shaped cross-section enables a very defined folding of the edge strip when a contact plate is pressed on. The uncontrolled compression mentioned at the beginning can therefore not occur.

It is preferred that both the edge strip of the anode current collector and the edge strip of the cathode current collector have a U-shaped or V-shaped cross-section.

Of course, the terms “U-shaped” and “V-shaped” in the context of the present invention are not to be interpreted as meaning that the cross-section has the shape of a perfect U or V. For example, when the contact plates are fitted, further deformation of the edge strip(s) may occur, so that, for example, a V-shaped cross-section is very pointed, i.e. the legs of the V enclose a very small angle, or the U is deformed in the region of its opening.

Furthermore: The edge strip or strips do not necessarily have a U-shaped or V-shaped cross-section in their entirety as a result of the forming process. Rather, it is preferred that only a section of the edge strip(s) is subjected to the forming process. In this preferred embodiment, the edge strip or edge strips thus comprise at least one section that is not deformed by the forming process. This preferably extends along the elongated depression or indentation or along the elongated elevation corresponding to the depression or indentation.

### Cylindrical Design

The energy storage element can be designed as a cylindrical round cell or also prismatic. In the cylindrical embodiment, it has the immediately following features a. to e:
a. The electrodes and the current collectors as well as the layers of electrode materials are ribbon-shaped,
b. It comprises at least one ribbon-shaped separator or at least one ribbon-shaped solid electrolyte layer,
c. the assembly is in the form of a cylindrical winding in which the electrodes and the at least one separator are spirally wound around a winding axis, wherein the assembly comprises a first and a second terminal end face and a winding shell and the free edge strip of the cathode current collector protrudes from the first end face and the free edge strip of the anode current collector protrudes from the second end face,
d. It comprises a cylindrical housing, in particular a cylindrical metal housing, comprising a circumferential housing shell and, at the end faces, a circular bottom and a lid, and
e. The assembly, which is designed as a winding, is axially aligned in the housing so that the winding shell abuts the inside of the circumferential housing shell.

In this embodiment, the assembly preferably comprises a ribbon-shaped separator or two ribbon-shaped separators, each of which has a first and a second longitudinal edge and two ends.

In this embodiment, the contact sheet metal members preferably sit flat on the two end faces.

The cylindrical design of the energy storage element has a number of particular advantages. It is known from the prior art that when manufacturing cylindrical windings from electrodes, a so-called “telescoping effect” can occur due to inaccurate winding of the electrode edges, which can result in uneven end faces of the winding. This results in dimensional, mechanical and welding problems. This effect can be avoided with edge strips formed as disclosed herein. The edge strip with the U-shaped or V-shaped cross-section can provide a guide during winding, so that inaccuracies during winding production are counteracted.

In this embodiment, the energy storage element is preferably characterized by the immediately following feature a:
a. The metal housing comprises a cup-shaped, cylindrical housing part with a terminal opening and a lid component which closes the terminal opening of the cup-shaped housing part.

Preferably, the lid component has a circular circumference and is arranged in the circular opening of the cup-shaped housing part in such a way that the edge abuts the inside of the cup-shaped housing part along a circumferential contact zone, wherein the edge of the lid component is connected to the cup-shaped housing part via a circumferential weld seam. In this case, the two housing parts preferably have the same polarity, i.e. they are electrically coupled to either a positive or a negative electrode. In this case, the housing also comprises a pole bushing, which is used to make electrical contact with the electrode that is not electrically connected to the housing.

In an alternative embodiment, an electrically insulating seal is fitted to the edge of the lid component, which electrically separates the lid component from the cup-shaped housing part. In this case, the housing is usually sealed by a crimp closure.

The height of energy storage elements designed as cylindrical round cells is preferably in the range from 50 mm to 150 mm. The diameter of the cylindrical round cells is preferably in the range from 15 mm to 60 mm. Cylindrical round cells with these form factors are particularly suitable for supplying power to electric drives in motor vehicles.

In embodiments in which the cell is a cylindrical round cell, the anode current collector, the cathode current collector and the separator or separators preferably have the following dimensions:
A length in the range from 0.5 m to 25 m
A width in the range from 30 mm to 145 mm

In this embodiment, the contact sheet metal members preferably have a circular basic shape.

In some preferred variants of the cylindrical embodiment, the energy storage element is characterized by at least one of the features a. to d. immediately below:
a. The ribbon-shaped positive electrode and thus also the free edge strip of the cathode current collector protruding from the first end face comprises a radial sequence of adjacent turns in the winding.
b. The elongated elevation of the free edge strip of the cathode current collector points radially outwards or radially inwards.
c. The ribbon-shaped positive electrode comprises at least one turn, preferably a plurality of turns, in which the elongate elevation of the free edge strip of the cathode current collector is inserted into the elongate depression or indentation of the free edge strip of the cathode current collector of a radially adjacent turn.
d. The free edge strip of the cathode current collector forms a continuous metal layer perpendicular to the first end face, covering at least 80% of the end face.

Preferably, the immediately preceding features a. to c., and preferably even features a. to d., are realized in combination with one another.

This embodiment is advantageous. Ideally, the continuous metal layer is a closed layer that completely covers the first end face.

The adjacent turns formed during the production of the winding have different diameters. Inner turns always have a smaller diameter than outer turns, or in other words, the diameter of the winding increases towards the outside with each turn of the winding.

In some further preferred variants of the cylindrical embodiment, the energy storage element is characterized by at least one of the features a. to d. immediately below:
a. The ribbon-shaped negative electrode and thus also the free edge strip of the anode current collector protruding from one of the end faces comprises a radial sequence of adjacent turns in the winding.
b. The elongated elevation of the free edge strip of the anode current collector points radially outwards or radially inwards.
c. The ribbon-shaped negative electrode comprises at least one turn, preferably a plurality of turns, in which the elongate elevation of the free edge strip of the anode current collector is inserted into the elongate depression or indentation of the free edge strip of the anode current collector of a radially adjacent turn.
d. The free edge strip of the anode current collector forms a continuous metal layer in the direction perpendicular to the second end face, which covers at least 80% of the end face.

Here, too, it is preferred that the immediately preceding features a. to c., and preferably even features a. to d., are realized in combination with one another.

### Prismatic Design

In the prismatic embodiment, the energy storage element is characterized by the features a. to d. immediately below:
a. The assembly is in the form of a prismatic stack in which the cathode and the anode are stacked together with other cathodes and anodes.
b. The electrodes and the current collectors as well as the layers of electrode materials are polygonal, in particular rectangular.
c. It comprises at least one ribbon-shaped or polygonal, in particular rectangular, separator or at least one ribbon-shaped or polygonal, in particular rectangular, solid electrolyte,
d. The stack is enclosed in a prismatic housing.

In the stack, oppositely polarized electrodes are always separated from each other by a separator or solid electrolyte layer.

The prismatic housing is preferably composed of a cup-shaped housing part with a terminal opening and a lid component. In this embodiment, the bottom of the cup-shaped housing part and the lid component preferably have a polygonal, preferably a rectangular base. The shape of the terminal opening of the cup-shaped housing part corresponds to the shape of the bottom and the lid component. In addition, the housing comprises several, preferably four, rectangular side parts which connect the bottom and the lid component to one another.

The separator layers can be formed by several separators, each of which is arranged between adjacent electrodes. However, it is also possible for a ribbon-shaped separator to separate the electrodes of the stack from each other. In the case of several separators between the anodes and cathodes, the separators preferably also have a polygonal, in particular rectangular, base area.

In this embodiment, the contact sheet metal members preferably have a rectangular base shape.

In some preferred variants of the prismatic embodiment, the energy storage element is characterized by at least one of the features a. to d. immediately below:
a. Each of the cathodes of the stack is characterized by the edge strip with the U- or V-shaped cross-section.
b. Each of the anodes of the stack is characterized by the edge strip with the U- or V-shaped cross-section.
c. The free edge strips of the cathode current collectors of the cathodes of the stack protrude from one side of the stack and are in direct contact with the first contact sheet metal member.
d. The free edge strips of the anode current collectors of the anodes of the stack protrude from another side of the stack and are in direct contact with the second contact sheet metal member.

Preferably, the immediately preceding features a. and c. as well as b. and d. are realized in combination with each other. Features a. to d. are preferably realized in combination with one another.

In further preferred variants of the prismatic embodiment, the energy storage element is characterized by at least one of the features a. to d. immediately below:
a. The free edge strips of the cathode current collectors are arranged parallel to each other.
b. The elongated elevations of the free edge strips of adjacent cathode current collectors point in the same direction.
c. Adjacent edge strips of the free edge strips of the cathode current collectors are coupled to the free edge strips of adjacent cathode current collectors by inserting their elongated projections into the elongated depressions or indentations of the free edge strips of the adjacent cathode current collectors.
d. The free edge strips of the cathode current collectors form a continuous metal layer in the direction perpendicular to the side of the stack from which they protrude, which completely covers at least 80% of the side.

Preferably, the immediately preceding features a. to c., and preferably even features a. to d., are realized in combination with one another.

In further preferred variants of the prismatic embodiment, the energy storage element is characterized by at least one of the features a. to d. immediately below:
a. The free edge strips of the anode current collectors are arranged parallel to each other.
b. The elongated elevations of the free edge strips of adjacent anode current collectors point in the same direction.
c. Adjacent edge strips of the free edge strips of the anode current collectors are coupled to the free edge strips of adjacent anode current collectors by inserting their elongated projections into the elongated depressions or indentations of the free edge strips of the adjacent anode current collectors.
d. The free edge strips of the anode current collectors form a continuous metal layer in the direction perpendicular to the side of the stack from which they protrude, which completely covers at least 80% of the side.

Preferably, the immediately preceding features a. to c., and preferably even features a. to d., are realized in combination with one another.

### Preferred Electrochemical Embodiment

In a further preferred embodiment, the energy storage element is characterized by one of the following features:
a. The energy storage element is a lithium-ion cell.
b. The energy storage element comprises a lithium-ion cell.

Feature a. refers in particular to the described embodiment of the energy storage element as a cylindrical round cell. In this embodiment, the energy storage element preferably comprises exactly one electrochemical cell.

Feature b. refers in particular to the described prismatic embodiment of the energy storage element. In this embodiment, the energy storage element may also comprise more than one electrochemical cell.

Basically, all electrode materials known for secondary lithium-ion cells can be used for the electrodes of the energy storage element.

Carbon-based particles such as graphitic carbon or non-graphitic carbon materials capable of intercalating lithium, preferably also in particle form, can be used as active materials in the negative electrodes. Alternatively or additionally, lithium titanate (Li₄Ti₅O₁₂) or a derivative thereof can also be contained in the negative electrode, preferably also in particle form. Furthermore, the negative electrode can contain as active material at least one material from the group comprising silicon, aluminum, tin, antimony or a compound or alloy of these materials that can reversibly store and release lithium, for example silicon oxide, optionally in combination with carbon-based active materials. Tin, aluminum, antimony and silicon can form intermetallic phases with lithium. The capacity to absorb lithium exceeds that of graphite or comparable materials many times over, especially in the case of silicon. Thin anodes made of metallic lithium are also possible.

Suitable active materials for the positive electrodes include lithium metal oxide compounds and lithium metal phosphate compounds such as LiCoO₂ and LiFePO₄. Lithium nickel manganese cobalt oxide (NMC) with the chemical formula LiNiₓMn_{y}Co_{z}O₂ (wherein x+y+z is typically 1) is also particularly suitable, lithium manganese spinel (LMO) with the chemical formula LiMn₂O₄, or lithium nickel cobalt aluminum oxide (NCA) with the chemical formula LiNiₓCo_{y}Al₂O₂ (wherein x+y+z is typically 1). Derivatives thereof, for example lithium nickel manganese cobalt aluminum oxide (NMCA) with the chemical formula Li_{1.11}(Ni_{0.40}Mn_{0.39}Co_{0.16}Al_{0.05})_{0.89}O₂ oder Li₁₊ₓM-O compounds and/or mixtures of the aforementioned materials can also be used. The cathodic active materials are also preferably used in particulate form.

In addition, the electrodes of an energy storage element preferably contain an electrode binder and/or an additive to improve the electrical conductivity. The active materials are preferably embedded in a matrix of the electrode binder, wherein adjacent particles in the matrix are preferably in direct contact with each other. Conductive agents have the function of elevating the electrical conductivity of the electrodes. Common electrode binders are based, for example, on polyvinylidene fluoride (PVDF), polyacrylate or carboxymethyl cellulose. Common conductive agents are carbon black and metal powder.

The energy storage element preferably comprises an electrolyte, in the case of a lithium-ion cell in particular an electrolyte based on at least one lithium salt such as lithium hexafluorophosphate (LiPF₆), which is present dissolved in an organic solvent (e.g. in a mixture of organic carbonates or a cyclic ether such as THE or a nitrile). Other lithium salts that can be used are, for example, lithium tetrafluoroborate (LiBF₄), lithium bis(trifluoromethanesulfonyl)imide (LiTFSI), lithium bis(fluorosulfonyl)imide (LiFSI) and lithium bis(oxalato)borate (LiBOB).

The nominal capacity of a lithium-ion-based energy storage element designed as a cylindrical round cell is preferably up to 90000 mAh. With the form factor of 21×70, the energy storage element in one embodiment as a lithium-ion cell preferably has a nominal capacity in the range from 1500 mAh to 7000 mAh, preferably in the range from 3000 to 5500 mAh. With the form factor of 18×65, the cell in one embodiment as a lithium-ion cell preferably has a nominal capacity in the range from 1000 mAh to 5000 mAh, preferably in the range from 2000 to 4000 mAh.

In the European Union, manufacturers' information on the nominal capacity of secondary batteries is strictly regulated. For example, information on the nominal capacity of secondary nickel-cadmium batteries must be based on measurements according to the IEC/EN 61951-1 and IEC/EN 60622 standards, information on the nominal capacity of secondary nickel-metal hydride batteries must be based on measurements according to the IEC/EN 61951-2 standard, information on the nominal capacity of secondary lithium batteries must be based on measurements according to the IEC/EN 61960 standard and information on the nominal capacity of secondary lead-acid batteries must be based on measurements according to the IEC/EN 61056-1 standard. Any information on nominal capacities in the present application is preferably also based on these standards.

### Preferred Embodiments of the Separator and the Solid Electrolyte

Preferably, the separator or separators are formed from electrically insulating plastic films. It is preferable that the separators can be penetrated by the electrolyte. For this purpose, the plastic films used can have micropores, for example. The foil can consist of a polyolefin or a polyether ketone, for example. Nonwovens and fabrics made of plastic materials or other electrically insulating fabrics can also be used as separators. Separators with a thickness in the range from 5 μm to 50 μm are preferred.

In particular in the prismatic embodiments of the energy storage element, the separator or separators of the assembly can also be one or more layers of a solid electrolyte.

The solid electrolyte is, for example, a polymer solid electrolyte based on a polymer-conducting salt complex, which is present in a single phase without any liquid component. A polymer solid-state electrolyte can have polyacrylic acid (PAA), polyethylene glycol (PEG) or polymethyl methacrylate (PMMA) as the polymer matrix. Lithium conductive salts such as lithium bis-(trifluoromethane) sulfonylimide (LiTFSI), lithium hexafluorophosphate (LiPF₆) and lithium tetrafluoroborate (LiBF₄) can be dissolved in these.

### Preferred Structure of an Assembly Formed as a Winding

The ribbon-shaped anode, the ribbon-shaped cathode and the ribbon-shaped separator(s) are preferably spirally wound in the assembly formed as a winding. To produce the assembly, the ribbon-shaped electrodes together with the ribbon-shaped separator(s) are fed to a winding device and preferably wound up spirally around a winding axis in the winding device. In some embodiments, the electrodes and the separator are wound onto a cylindrical or hollow-cylindrical winding core for this purpose, which is seated on a winding mandrel and remains in the winding after winding.

The winding shell can be formed by a plastic film or an adhesive tape, for example. It is also possible for the winding shell to be formed by one or more separator windings.

### Preferred Embodiments of the Current Collectors

The current collectors of the energy storage element have the function of electrically contacting the electrochemically active components contained in the respective electrode material over as large an area as possible. Preferably, the current collectors consist of a metal or are at least metallized on the surface. In the case of an energy storage element based on lithium-ion technology, suitable metals for the anode current collector include copper or nickel or other electrically conductive materials, in particular copper and nickel alloys or nickel-coated metals. Stainless steel is also an option. In the case of an energy storage element based on lithium-ion technology, aluminum or other electrically conductive materials, including aluminum alloys, are particularly suitable as a metal for the cathode current collector.

Preferably, the anode current collector and/or the cathode current collector are each a metal foil with a thickness in the region of 4 μm to 30 μm, in the case of the described configuration of the energy storage element as a cylindrical round cell, a ribbon-shaped metal foil with a thickness in the range from 4 μm to 30 μm.

In addition to foils, however, other strip-shaped substrates such as metallic or metallized nonwovens or open-pored metallic foams or expanded metals can also be used as current collectors.

In the case of the described configuration of the energy storage element as a cylindrical round cell, it is preferred that the longitudinal edges of the separator(s) form the end faces of the assembly, which is designed as a winding.

In the case of the described prismatic configuration of the energy storage element, it is preferred that the edges of the separator(s) form the sides of the stack from which the free edge strips of the current collectors protrude.

It is further preferred that the free edge strips of the current collectors protruding from the terminal end faces of the winding or sides of the stack do not project more than 5500 μm, preferably not more than 4000 μm, from the end faces or sides.

Preferably, the free edge strip of the anode current collector protrudes from the side of the stack or the end face of the winding by no more than 3000 μm, preferably by no more than 2000 μm. Preferably, the free edge strip of the cathode current collector protrudes from the side of the stack or the end face of the winding by no more than 4000 μm, preferably by no more than 3000μ m.

### Embodiments of the First Contact Sheet Metal Member/Connection of the First Contact Sheet Metal Member to the Anode Current Collector

The first contact sheet metal member is preferably electrically connected to the anode current collector. It is preferably connected directly to the free edge strip of the anode current collector by welding.

In addition or in an alternative embodiment, the first contact sheet metal member can also be mechanically connected to the free edge strip of the anode current collector, for example by a press connection or a clamp connection or a spring connection.

In a preferred embodiment, the first contact sheet metal member is characterized by at least one of the features a. or b. immediately below:
a. The contact sheet metal member consists of nickel or copper or titanium or a nickel or copper or titanium alloy or stainless steel.
b. The contact sheet metal member consists of the same material as the anode current collector.

It is preferred that the immediately preceding features a. and b. are realized in combination with each other.

The contact sheet metal member is either electrically connected to the housing or to a contact pole that passes through the housing and is electrically insulated from the housing. The electrical contact can be realized by welding or a mechanical connection. If necessary, the electrical connection can also be made via a separate electrical conductor.

In a further preferred embodiment, the first contact sheet metal member is characterized by at least one of the features a. to g. immediately below:
a. The contact sheet metal member has a preferably uniform thickness in the range from 50 μm to 600 μm, preferably in the range from 150 μm to 350 μm.
b. The contact sheet metal member has two opposite flat sides and extends essentially in only one dimension.
c. The contact sheet metal member is a disk or preferably a rectangular plate.
d. The contact sheet metal member is dimensioned such that it covers at least 60%, preferably at least 70%, preferably at least 80%, of the side or end face from which the free edge strip of the anode current collector connected to it emerges.
e. The contact sheet metal member has at least one aperture, in particular at least one hole and/or at least one slot.
f. The contact sheet metal member has at least one bead, which appears on one flat side of the contact sheet metal member as an elongated depression and on the opposite flat side as an elongated elevation, wherein the contact sheet metal member sits with the flat side, which carries the elongated elevation, on the free edge strip of the anode current collector.
g. The contact sheet metal member is welded to the free edge strip of the anode current collector in the region of the bead, in particular via one or more weld seams arranged in the bead.

It is preferred that the immediately preceding features a. and b. and d. are realized in combination with each other. In a preferred embodiment, features a. and b. and d. are realized in combination with one of features c. or e. or features f. and g. Preferably, all features a. to g. are realized in combination with each other.

Covering as much of the end face as possible is important for the thermal management of the grounded energy storage element. The larger the cover, the easier it is to contact the first edge of the anode current collector over its entire length. Heat formed in the assembly can thus be dissipated well via the contact sheet metal member.

The at least one aperture in the contact sheet metal member can be expedient, for example, in order to be able to impregnate the assembly with an electrolyte.

### Embodiments of the Second Contact Sheet Metal Member/Connection of the Second Contact Sheet Metal Member to the Cathode Current Collector

The second contact sheet metal member is preferably electrically connected to the cathode current collector. It is preferably connected to the free edge strip of the cathode current collector directly by welding.

In an alternative embodiment, however, the second contact sheet metal member can also be mechanically connected to the free edge strip of the cathode current collector, for example by means of a press connection, a spring connection or a clamp connection.

In a preferred embodiment, the energy storage element is characterized by the feature a. immediately below:
a. The second contact sheet metal member consists of aluminum or an aluminum alloy.

The contact sheet metal member is either electrically connected to the housing or to a contact pole that passes through the housing and is electrically insulated from the housing. The electrical contact can be realized by welding or a mechanical connection. If necessary, the electrical connection can also be made via a separate electrical conductor.

The second contact sheet metal member is preferably, apart from its material properties, similar to the contact sheet metal member resting on the free edge strip of the anode current collector. It is preferably characterized by at least one of the features a. to g. immediately below:
a. The second contact sheet metal member has a preferably uniform thickness in the range from 50 μm to 600 μm, preferably in the range from 150 μm to 350 μm.
b. The second contact sheet metal member has two opposite flat sides and extends essentially in only one dimension.
c. The second contact sheet metal member is a disk or preferably a rectangular plate.
d. The second contact sheet metal member is dimensioned such that it covers at least 60%, preferably at least 70%, preferably at least 80%, of the side or end face from which the free edge strip of the cathode current collector emerges.
e. The second contact sheet metal member has at least one aperture, in particular at least one hole and or at least one slot.
f. The second contact sheet metal member has at least one bead, which appears on one flat side of the contact sheet metal member as an elongated depression and on the opposite flat side as an elongated elevation, wherein the contact sheet metal member sits with the flat side, which carries the elongated elevation, on the free edge strip of the cathode current collector.
g. The second contact metal member is welded to the free edge strip of the cathode current collector in the region of the bead, in particular via one or more weld seams arranged in the bead.

Here, too, it is preferred that the immediately preceding features a. and b. and d. are realized in combination with one another. In a preferred embodiment, features a. and b. and d. are realized in combination with one of features c. or e. or features f. and g. In a preferred embodiment, all features a. to g. are also realized in combination with each other.

The connection or welding of the free edge strip of the cathode current collector to the second contact sheet metal member is preferably realized in the same way as the connection of the free edge strip of the anode current collector described above, i.e. preferably via a weld in the region of the bead.

In preferred embodiments, the second contact sheet metal member is welded directly to the bottom of the cup-shaped housing part or a part of the bottom. In further preferred embodiments, the second contact sheet metal member is connected to the bottom of the cup-shaped housing part via a separate current conductor. In the latter case, it is preferred that the separate current conductor is welded both to the bottom of the cup-shaped housing part and to the second contact sheet metal member. The separate current conductor preferably consists of aluminum or an aluminum alloy.

### Preferred Embodiment of the Housing Parts

In a further preferred embodiment, the energy storage element is characterized by at least one of the features a. and b. immediately below:
a. The cup-shaped housing part consists of aluminum, stainless steel or nickel-plated steel.
b. The lid component consists of aluminum, stainless steel or nickel-plated steel.

The immediately preceding features a. and b. are preferably realized in combination.

In some embodiments, a direct connection of the free edge strip of the cathode current collector to the housing is desirable. For this purpose, the free edge strip can be welded to the bottom of the cup-shaped housing part using a laser, for example. In this case, the bottom of the cup-shaped housing part serves as a second contact plate.

Conversely, in some embodiments, it may be provided that the first contact plate serves as a lid component, i.e. serves as part of the housing.

### Preferred Embodiment of the Electrodes

In a further preferred embodiment, the energy storage element is characterized by one of the features a. or b. immediately below:
a. The energy storage element is designed as a cylindrical round cell and its electrodes have a thickness in the range from 40 μm to 300 μm, preferably in the region from 40 μm to 100 μm.
b. The energy storage element is prismatic and its electrodes have a thickness in the range from 40 μm to 1000 μm, preferably a thickness>100 μm to a maximum of 300 μm.

### Method

A method is provided that is used to manufacture the energy storage element described above, in particular an energy storage element having the following features:
a. It comprises a cathode and an anode which are parts of an assembly in which they are present, separated by a separator or solid electrolyte layer, in the sequence cathode/separator or solid electrolyte layer/anode,
b. the cathode comprises a cathode current collector and a positive electrode material,
c. the cathode current collector has
a main region loaded on both sides with a layer of the positive electrode material, and
a free edge strip which extends along one edge of the cathode current collector and which is not loaded with the positive electrode material,
d. the anode comprises an anode current collector and a negative electrode material,
e. the anode current collector has
a main region loaded on both sides with a layer of the negative electrode material, and
a free edge strip which extends along one edge of the anode current collector and which is not loaded with the negative electrode material,
f. the cathode and the anode are formed and/or arranged relative to each other within the electrode-separator assembly in such a way that the free edge strip of the cathode current collector protrudes from one side of the assembly and the free edge strip of the anode current collector protrudes from another side of the assembly, and
g. the energy storage element comprises a first contact sheet metal member which is in direct contact with one of the free edge strips and a second contact sheet metal member which is in direct contact with the other of the free edge strips.

With regard to preferred embodiments of the individual components of the energy storage element to be manufactured, reference is made to the above explanations in connection with the explanation of the energy storage element.

The method is characterized in particular by the following step:
h. Before the assembly is formed, at least one edge strip is subjected to a forming process, as a result of which it has a U-shaped or V-shaped cross-section and thus an elongated depression or indentation on one side and an elongated elevation corresponding to the depression on the other side.

In a preferred embodiment, the method is additionally characterized by the following step:
a. For forming, the edge strip to be formed is guided through a V- or U-shaped gap formed by rollers or compactors.

In a further preferred embodiment, the method is additionally characterized by a combination of the immediately following steps a. to e.:
a. Ribbon-shaped electrodes with ribbon-shaped current collectors and ribbon-shaped layers of the electrode materials are used to form the assembly,
b. At least one ribbon-shaped separator or at least one ribbon-shaped solid electrolyte layer is used to form the assembly,
c. The assembly is formed in the form of a cylindrical winding by winding the electrodes and the at least one ribbon-shaped separator or the at least one ribbon-shaped solid electrolyte layer spirally around a winding axis,
d. When winding the electrodes, a sequence of adjacent turns is created, and
e. When winding the electrodes, the elongated elevation of the edge strip of an electrode turn is pushed into the elongated depression or indentation of an adjacent turn.

This process variant is used to manufacture an energy storage element in a cylindrical design.

In another preferred embodiment, the method is additionally characterized by a combination of the immediately following steps a. to f:
a. Polygonal electrodes are used to form the assembly,
b. The assembly is formed in the form of a prismatic stack in which the cathode and the anode are stacked together with other cathodes and anodes,
c. Each of the cathodes of the stack is characterized by the edge strip with the U- or V-shaped cross-section.
d. Each of the anodes of the stack is characterized by the edge strip with the U- or V-shaped cross-section.
e. When forming the stack, the free edge strips of the cathode current collectors are coupled with the free edge strips of adjacent cathode current collectors by inserting their elongated projections into the elongated depressions or indentations of the free edge strips of the adjacent cathode current collectors.
f. When forming the stack, the free edge strips of the anode current collectors are coupled with the free edge strips of adjacent cathode current collectors by inserting their elongated projections into the elongated depressions or indentations of the free edge strips of the adjacent cathode current collectors.

This process variant is used to manufacture an energy storage element in a prismatic design.

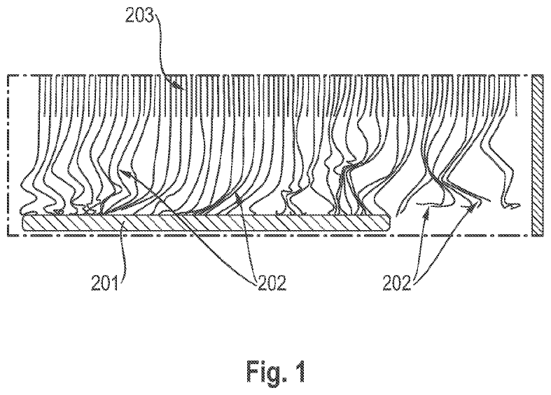

FIG. 1 illustrates the result of pressing a contact plate 201 onto a protruding edge 202 of a current collector protruding from one side of an assembly 203 consisting of negative and positive electrodes and separators (not shown in the drawing) in between. During the press-on, uncontrolled compression of the edge 202 of the current collector occurred. The compression in turn results in some undefined folds, as can be seen particularly clearly in the right-hand region of the edge 202. This makes large-area, form-fit contact between the current collector edge 202 and the contact plate 201 more difficult.

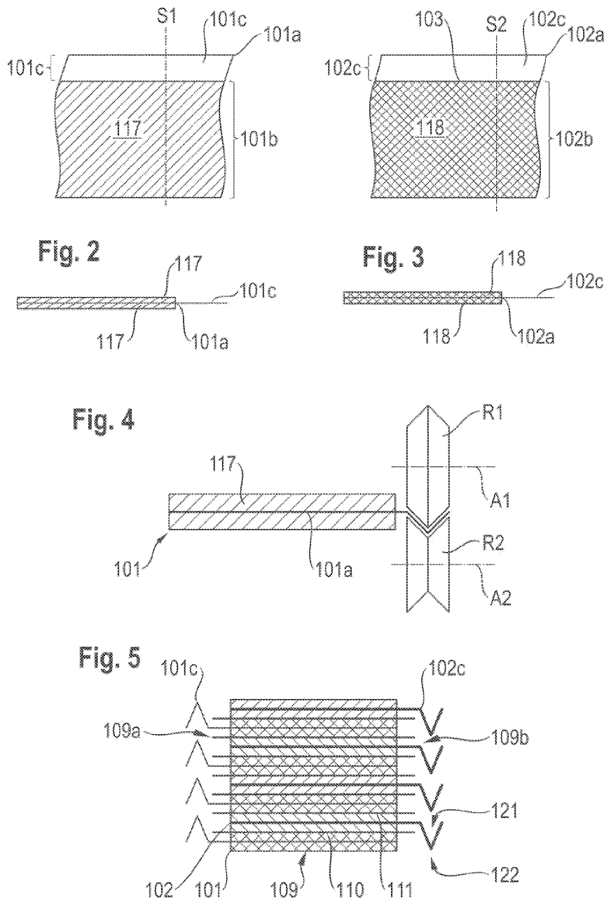

FIG. 2 shows a current collector 101a, to which a layer of a positive electrode material 117 is applied on both sides, firstly in a plan view from above and secondly in a cross-sectional view (section along S1). The current collector 101 is preferably an aluminum foil.

The strip-shaped current collector 101a comprises a main region 101b loaded with the electrode material 117 and a strip-shaped edge strip 101c, which is free of electrode material.

FIG. 3 shows a current collector 102a, to which a layer of a negative electrode material 118 is applied on both sides, firstly in a plan view from above and secondly in a cross-sectional view (section along S2). The current collector 101 is preferably a copper foil.

The strip-shaped current collector 102a comprises a main region 102b loaded with the electrode material 118 and a strip-shaped edge strip 102c, which is free of electrode material.

FIG. 4 illustrates the formation of an edge strip with a V-shaped cross-section. The free edge strip 101c of a current collector 101a, as shown in FIG. 2, is guided in the longitudinal direction through a V-shaped gap formed by two rollers R1 and R2. In the process, the edge strip 101c is deformed and is given the V-shaped cross-section that characterizes it, with an elongated depression or indentation 121 on one side and an elongated elevation 122 corresponding to the depression 121 on the other side.

The result of such a process is illustrated in FIG. 5. Shown is a section through several turns of a cylindrical assembly 109 formed by spirally winding a ribbon-shaped cathode 101 and a ribbon-shaped anode 102. Within the assembly 109, the cathode 101 and the anode 102 are separated from each other by two ribbon-shaped separator or solid electrolyte layers 110 and 111. Both the cathode 101 and the anode 102 were subjected to a pretreatment according to FIG. 4, in the course of which the free edge strips 101c and 102c of their current collectors were given a V-shaped cross-section.

The assembly 109, which is formed as a cylindrical winding, has a first and a second terminal end face 109a, 109b and a winding shell. The free edge strip 101c of the cathode current collector protrudes from the first end face 109a and the free edge strip 102c of the anode current collector protrudes from the second end face 109b.

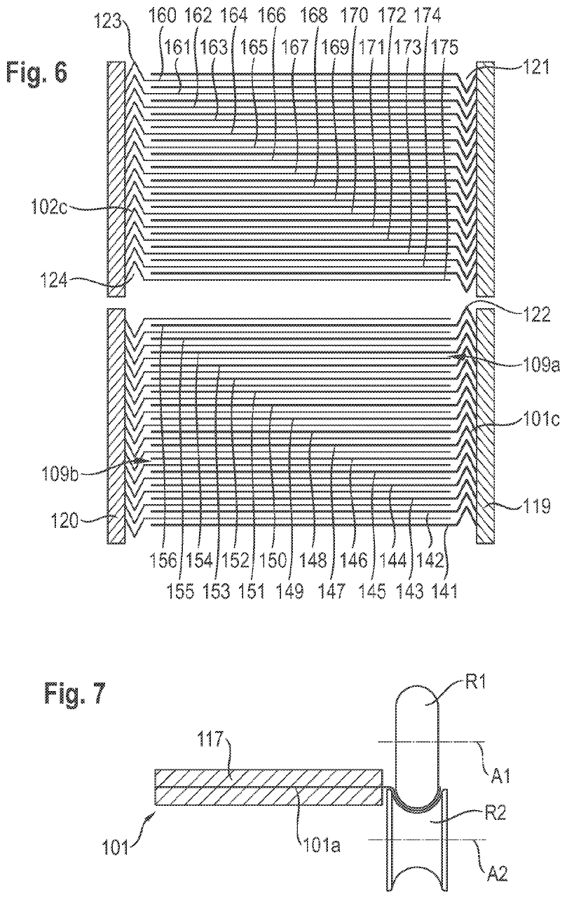

FIG. 6 shows a sectional view of a further embodiment of a cylindrical assembly formed as a winding, which was formed by spirally winding a tape-shaped cathode and a tape-shaped anode. The winding has a first end face 109a and a second end face 109b. For an improved overview, only the current collectors 101a and 102a together with their respective free edge strips 101c and 102c are shown here. The electrode materials and the separators arranged between the electrodes are not shown.

The free edge strip 101c of the cathode current collector protruding from the end face 109a comprises a radial sequence of adjacent turns 141-156 in the winding. The free edge strip 102c of the anode current collector protruding from the end face 109b comprises a radial sequence of adjacent turns 160-174 in the winding. The free edge strips 101c and 102c were subjected to a pretreatment according to FIG. 4, in the course of which they were each given a V-shaped cross-section. In the winding itself, the anode and cathode were arranged slightly offset from each other. In the picture, the elongated elevation 122 of the free edge strip 101c of the cathode current collector points radially inwards and the elongated elevation 123 of the free edge strip 102c of the anode current collector points radially outwards. It is of course also conceivable that, in alternative embodiments, the elongate elevations 122 and 123 point inwards in both cases or outwards in both cases, or that the elongate elevation 123 points radially inwards and the elongate elevation 122 points radially outwards.

The width of the edge strips 101c and 102c is dimensioned in such a way that the elongated elevation of a turn is inserted into the elongated depression or indentation of a radially adjacent turn. On the cathode side, the elevation 122 of each turn (except the innermost and the outermost) is inserted into the depression 121 of the next inner turn. On the anode side of each turn (except the innermost and the outermost), the projection 123 is inserted into the depression 124 of the next outermost turn.

As a result, the free edge strip 101c of the cathode current collector forms a continuous metal layer in the direction of view perpendicular to the end face 109a, which completely covers the end face 109a in the present case. The same is the case on the anode side, where the free edge strip 102c of the anode current collector forms a continuous metal layer in the direction of view perpendicular to the end face 109b, which completely covers the end face 109b in the present case.

The end faces 109a and 109b of the winding are covered by the contact sheet metal members 119 and 120. The contact sheet metal member 119 is in direct contact with the edge strip 101c, the contact sheet metal member 120 is in direct contact with the edge strip 102c. When the contact sheet metal members are applied, the edge strips 101c and 102c can be pressed together slightly. Conversely, the edge strips 101c and 102c can exert a spring force on the contact sheet metal members, which strengthens the contact with the sheets. A welded connection is preferred between the contact sheet metal members 119 and 120 and the edge strips.

FIG. 7 illustrates the formation of an edge strip with a U-shaped cross-section. The free edge strip 101c of a cathode 101, as shown in FIG. 2, is guided in the longitudinal direction through a U-shaped gap formed by two rollers R1 and R2. In the process, the edge strip 101c is deformed and is given the U-shaped cross-section that characterizes it, with an elongated depression or indentation 121 on one side and an elongated elevation 122 corresponding to the depression 121 on the other side.

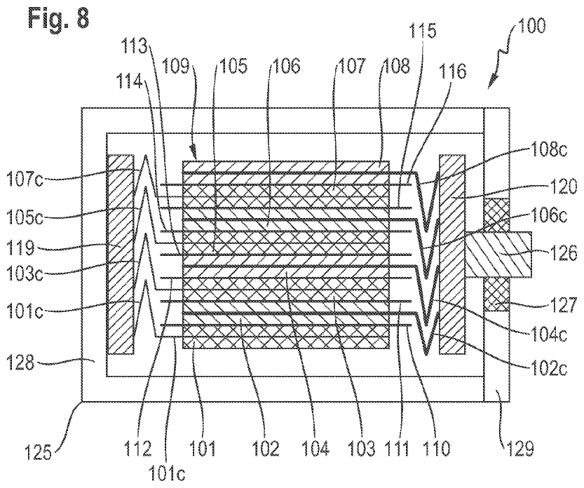

FIG. 8 shows an energy storage element 100. It comprises the prismatic assembly 109 and a prismatic housing 125. The prismatic housing 125 is composed of the cup-shaped housing part 128 and the lid component 129. The contact pole 126, which is connected to the contact sheet metal member 120 by welding, is guided through the lid component 129. The contact pole 126 is electrically insulated from the lid component 129 by means of the insulating element 127. The contact sheet metal member 119 is welded to the bottom of the housing part 128.

The housing part contains the assembly 109, which is in the form of a prismatic stack. The positive electrodes 101, 103, 105 and 107 and the negative electrodes 102, 104, 106 and 108 are stacked in the stack, separated in each case by separator layers 110, 111, 112, 113, 114, 115 and 116. The electrodes each have a rectangular basic shape.

The free edge strips 101c, 103c, 105c and 107c of the positive electrodes and the free edge strips 102c, 104c, 106c and 108c of the negative electrodes were subjected to a pre-treatment according to FIG. 4, in the course of which they were each given a V-shaped cross-section. They thus each have one side with an elongated depression and another side with an elongated elevation.

The free edge strips 101c, 103c, 105c, 107c protrude from one side of the prismatic stack and are all in direct contact with the contact sheet metal member 119. They are all arranged parallel to each other and the elongated elevations of the edge strips all point in the same direction. The free edge strips 102c, 104c, 106c and 108c protrude from the opposite side of the prismatic stack and are all in direct contact with the contact sheet metal member 120. They are also all arranged parallel to each other and their elongated protrusions also all point in the same direction.

The free edge strips 101c, 103c, 105c and 107c are coupled to one another via their elongated elevations or their elongated depressions or indentations. Thus, the elongated elevation of the edge strip 101c is inserted into the elongated depression or indentation of the edge strip 103c, the elongated elevation of the edge strip 103c is inserted into the elongated depression or indentation of the edge strip 105c and the elongated elevation of the edge strip 105c is inserted into the elongated depression or indentation of the edge strip 107c. The picture is the same on the anode side, here the elongated elevation of the edge strip 108c is inserted into the elongated depression or indentation of the edge strip 106c, the elongated elevation of the edge strip 106c is inserted into the elongated depression or indentation of the edge strip 104c and the elongated elevation of the edge strip 104c is inserted into the elongated depression or indentation of the edge strip 102c. As a result, the free edge strips 101c, 103c, 105c and 107c form a continuous metal layer that almost completely covers the side of the stack when viewed perpendicularly to the side from which they protrude. On the anode side, the free edge strips 102c, 104c, 106c and 108c form a continuous metal layer perpendicular to the side of the stack from which they protrude, which covers this side almost completely.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An energy storage element, comprising:
a cathode comprising a cathode current collector comprising a main region loaded on both sides with a layer of positive electrode material and a first free edge strip not loaded with the positive electrode material, the first free edge strip extending along an edge of the cathode current collector;
an anode comprising an anode current collector comprising a main region loaded on both sides with a layer of negative electrode material and a second free edge strip not loaded with the negative electrode material, the second free edge strip extending along an edge of the anode current collector; and
a first contact sheet metal member in direct contact with the cathode current collector and a second contact sheet metal member in direct contact with the anode current collector,
wherein the cathode and the anode are separated by a separator or a solid electrolyte layer and form a sequence cathode/separator or solid electrolyte layer/anode,
wherein a respective free edge strip of the first free edge strip or the second free edge strip has, as a result of a forming process, a U-shaped or V-shaped cross-section and thus an elongated depression on one side and an elongated elevation corresponding to the depression on an opposite side, and
wherein a respective portion of the elongated elevation is inserted into one of:
a portion of the elongated depression, the portion of the elongated depression being disposed in a turn of the respective free edge strip that is radially adjacent to the respective portion of the elongated elevation, or
an elongated depression of a further free edge strip of a further electrode.

2. The energy storage element according to claim 1, further comprising a cylindrical housing comprising a circumferential housing shell, a circular bottom, and a lid,
wherein the anode and cathode are ribbon-shaped,
wherein at least one ribbon-shaped separator or at least one ribbon-shaped solid electrolyte layer separates the anode and the cathode,
wherein the anode, the cathode, and the at least one ribbon-shaped separator or the at least one ribbon-shaped solid electrolyte layer are spirally wound around a winding axis to form a cylindrical winding assembly,
wherein the cylindrical winding assembly comprises a first end face, a second end face, and a winding shell, and
wherein the first free edge strip protrudes from the first end face and the second free edge strip protrudes from the second end face,
wherein the respective portion of the elongated elevation is inserted into the portion of the elongated depression disposed in the turn of the respective free edge strip that is radially adjacent to the respective portion of the elongated elevation, and
wherein the cylindrical winding assembly is axially aligned such that the winding shell abuts the inside of the circumferential housing shell.

3. The energy storage element according to claim 2, wherein at least one of:
the cathode and the first free edge strip form a radial sequence of adjacent turns in the cylindrical winding assembly,
the elongated elevation points radially outwards or radially inwards,
the respective free edge strip is the first free edge strip, or
the first free edge strip forms a continuous metal layer in a direction perpendicular to the first end face that covers at least 80% of the first end face.

4. The energy storage element according to claim 2, wherein at least one of:
the anode and the second free edge strip form a radial sequence of adjacent turns in the cylindrical winding assembly,
the elongated elevation that points radially outwards or radially inwards,
the respective free edge strip is the second free edge strip, or
the second free edge strip forms a continuous metal layer in a direction perpendicular to the second end face that covers at least 80% of the second end face.

5. The energy storage element according to claim 1, further comprising one or more further cathodes and one or more further anodes,
wherein
the cathode and the anode are polygonal,
wherein the first cathode, the first anode, the one or more further cathodes, and the one or more further anodes are stacked together with a separator or a solid electrolyte layer disposed between adjacent cathode layers and anode layers to form a prismatic stack assembly,
wherein the respective portion of the elongated elevation is inserted into an elongated depression or indentation of a further free edge strip of a further electrode, the further electrode being one of the further cathodes or one of the further anodes, and
wherein the stack is enclosed in a prismatic housing.

6. The energy storage element according to claim 5, wherein at least one of:
the first free edge strip includes the U-shaped or V-shaped cross-section,
the second free edge strip includes the U-shaped or V-shaped cross-section,
the first free edge strip protrudes from one side of the stack and is in direct contact with the first contact sheet metal member, or
the second free edge strip protrudes from another side of the stack and is in direct contact with the second contact sheet metal member.

7. The energy storage element according to claim 5, wherein at least one of:
the further cathodes include further cathode free edge strips arranged parallel to each other and protruding from a first side of the prismatic stack,
the further cathode free edge strips include elongated elevations that point in a same direction,
adjacent cathode free edge strips are coupled together by respective elongated elevations being inserted into respective elongated depressions, or
the further cathode free edge strips form a continuous metal layer that completely covers at least 80% of a side of the prismatic stack extending in a direction perpendicular to the first side of the prismatic stack.

8. The energy storage element according to claim 5, wherein at least one of:
the further anodes include further anode free edge strips arranged parallel to each other and protruding from a second side of the prismatic stack,
the further anode free edge strips include elongated elevations that point in a same direction,
adjacent anode free edge strips are coupled together by respective elongated elevations being inserted into respective elongated depressions, or
the further anode free edge strips form a continuous metal layer that completely covers at least 80% of a side of the prismatic stack extending in a direction perpendicular to the second side of the prismatic stack.

9. The energy storage element according to claim 1, wherein:
the first contact sheet metal member is connected to the first free edge strip by welding and/or the second contact sheet metal member is connected to the second free edge strip by welding, and
the first contact sheet metal member is mechanically connected to the first free edge strip and/or the second contact sheet metal member is mechanically connected to the second free edge strip.

10. A method of manufacturing the energy storage element according to claim 1, the method comprising: subjecting the respective free edge strip to a forming process to produce the U-shaped or V-shaped cross-section; and
pushing the portion of the elongated elevation into one of:
the portion of the elongated depression being disposed in the turn of the respective free edge strip that is radially adjacent to the respective portion of the elongated elevation, or
the elongated depression of the further free edge strip of the further electrode.

11. The method according to claim 10, wherein subjecting the respective free edge strip to the forming process comprises guiding the respective free edge strip through a V- or U-shaped gap formed by rollers or compactors.

12. The method according to claim 10, wherein:
the anode and cathode are ribbon-shaped,
at least one ribbon-shaped separator or at least one ribbon-shaped solid electrolyte layer separates the anode and the cathode,
the cylindrical winding assembly is formed by winding the anode, the cathode, and the at least one ribbon-shaped separator or the at least one ribbon-shaped solid electrolyte layer around a winding axis,
when winding the electrodes, a radial sequence of adjacent turns is created, and
the respective portion of the elongated elevation is pushed into the portion of the elongated depression disposed in the turn of the respective free edge strip that is radially adjacent to the respective portion of the elongated elevation during the winding of the electrodes.

13. The method according to claim 10, wherein:
one or more further cathodes and one or more further anodes are provided,
the cathode, the anode, the one or more further cathodes, and the one or more further anodes are polygonal,
the first cathode, the first anode, the one or more further cathodes, and the one or more further anodes are stacked together with a separator or a solid electrolyte layer disposed between adjacent cathode layers and anode layers to form a prismatic stack,
each of the further cathodes comprises a free edge strip with a U- or V-shaped cross-section,
each of the further anodes comprises a free edge strip with a U- or V-shaped cross-section,
when forming the stack, the free edge strips of the cathode and the further cathodes are coupled with the free edge strips of adjacent cathodes by inserting respective elongated projections into corresponding elongated depressions, and
when forming the stack, the free edge strips of the anode and the further anodes are coupled with the free edge strips of adjacent anodes by inserting respective elongated projections into corresponding elongated depressions.
